(19) United States
(12) Patent Application Publication
(10) Pub. No.: US 2002/0156553 A1
(43) Pub. Date: Oct. 24, 2002

(54) Public access vehicle system

(76) Inventor: Lewis C. Read, Annandale, VA (US)

Correspondence Address: Volentine Francos, 12200 Sunrise Valley Drive, Suite 150, Reston, VA, 20191, US

(21) Appl. No.: 09/958,659

(22) PCT Filed: Jan. 3, 2001
(86) PCT No.: PCT/US01/06506

(51) Int. Cl. G06F 7/00

(52) U.S. Cl. 701/1

(57) ABSTRACT

A public access vehicle system and method of use is described. The system may include a number of vehicles, a number of automated check-out units and a central computer system operatively coupled to the automated check-out units and the vehicles for monitoring use of the system in real-time. The system may also include demand predicting software operatively coupled to the central computer and the automated check-out units to insure a high degree of vehicle accessibility and dependability.

### TECHNICAL FIELD

The present invention relates generally to a method and apparatus for a public access vehicle system, and particularly to a system for shared use of vehicular transportation.

### BACKGROUND

The cost of owning an automobile or other personal vehicle does not end with the capital expense of its purchase. A personal vehicle must be suitably insured and registered, and often in urban settings, storing a vehicle in a parking garage may significantly add to the cost. Moreover, these expenses are rather fixed, and they are no direct relation to the amount of use of the vehicle. In large communities, particularly in urban settings, where mass transit is readily available, the need for a personal vehicle is significantly minimized when compared to suburban or rural settings. As such, the cost of owning a vehicle per mile driven can be exceedingly expensive for the urban dweller.

Nonetheless, there may be situations where people in an urban setting will require a personal vehicle, for example an automobile, truck or other form of personal transportation. For these situations, the urban dweller may need to have access to a vehicle for a short period of an hour or two, or even longer duration of time. While the rental car industry is available, it typically caters to the business traveler, and its access is generally limited to airports; the few rental locations in cities are generally far a part. Moreover, the cost of conventional rental vehicles is prohibitive for the private user desiring a vehicle on a periodic basis, such as the urban dweller who needs the vehicle for a personal trip outside of the city.

What is needed, therefore is a system which enables car sharing providing an increase level of service and access to authorized users.

### SUMMARY OF THE INVENTION

It is an object to provide a system that would anticipate customer demand and have a vehicle waiting for a customer without the customer having to make a reservation. It is also an object to provide a system that could economically let a user check-out a car from hundreds of convenient locations throughout a city and a system that would offer all the freedom and dependability of a private vehicle but through a car sharing operation.

To accomplish these and other objects, according to an exemplary embodiment of the present invention an automated personal vehicle service system includes an automated check-out unit, which is operatively coupled to at least one vehicle. The automated check-out unit is responsive to a customer request and may enable the at least one vehicle for use by a customer.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a functional block diagram of the public access vehicle system according to an illustrative embodiment of the present invention.

FIG. 2 is a functional block diagram of a central computer, an automated check-out unit, a vehicle and related databases according to an illustrative embodiment of the present invention.

FIG. 3 is a functional block diagram showing an interaction of various software modules with hardware units according to an illustrative embodiment of the present invention.

FIG. 3a is a functional block diagram showing further interaction of the various software modules with hardware units according to an illustrative embodiment of the present invention.

FIG. 4 shows the operational database tables according to an illustrative embodiment of the present invention.

FIG. 5 shows various tables according to an illustrative embodiment of the present invention.

### DETAILED DESCRIPTION OF THE DRAWINGS

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

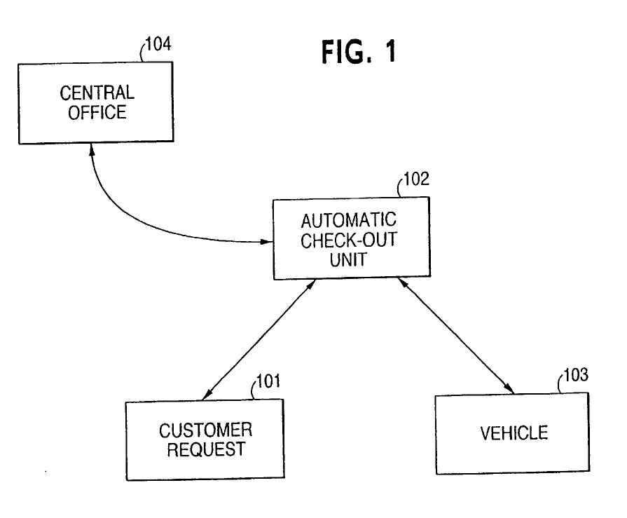

Briefly, the invention is drawn to a method and apparatus for enabling authorized users to share a plurality of vehicles. Turning to FIG. 1, a system overview (architecture) according to an illustrative embodiment of the present invention is disclosed. A customer request 101 is effected in the illustrative embodiment by an authorized user's placing a request with the automated check-out unit 102. The automated check-out unit 102 may be a freestanding device, similar to an automated teller machine. However, it is clear that other types of user interfaces are possible, for example an on-line website interface. In the illustrative embodiment in which the automated check-out unit 102 is a freestanding device similar to an automated teller machine (ATM), the user may insert an identification card into a card reader, such as a magnetic card reader which is disposed in the automated check-out unit 102. The automated check-out unit 102 may then ask for a validation number to be input to an alpha-numeric keypad on the automated check-out unit 102. The automated check-out unit 102 will verify the particular user's validation information against stored data in an illustrative on-site database. After this check, the customer will be prompted by the automated check-out unit 102 to select a particular type of vehicle. The computer will then check to see the availability of the vehicle, and may perform other tasks at this point as well. For example, the computer may check to see if the customer's account has a zero-balance before authorizing further use. Upon satisfactory completion of the availability and balance check, the automated check-out unit 102 will send a signal to a control unit in a vehicle 103 authorizing its use by the particular user. Illustratively a control signal from the automated check-out unit 102 will instruct a control unit (not shown) within the vehicle 103 to unlock the doors and enable the ignition. Suitable instructions will then be given by the automated check-out unit 102 to the user as to the location of the vehicle. It is anticipated that this process will take on the order of approximately 15 to approximately 20 seconds in total.

In the illustrative embodiment of FIG. 1, the automated check-out unit 102 may be a freestanding device or a device in part of a central website. Each automated check-out unit 102 illustratively includes its own database and its own control system, (e.g. a computer). Consequently, in the exemplary embodiment each automated check-out unit 102 may be self-contained with all necessary information required for a customer to check-out a vehicle for personal use. As a result, the response time between the entry of the validation number of the customer and his/her approval can be significantly reduced when compared to conventional shared vehicle systems, for example automobile rental systems.

In the illustrative embodiment shown in FIG. 1, the automated check-out unit 102 may be in communication with a central office 104 which has a central computer system at a headquarters site, for example. The automated check-out unit 102 may be in continuous communication with central office 104 via conventional phone lines. Alternatively, the communication link between the automated check-out unit 102 and the central office 104 may be via other known telecommunications and datacommunications media. These may be a fiber based link; a wireless based link; a cellular based link (including satellite); and other known media. Furthermore, the hardware and software supporting these conventional links arc well known, and further discussion thereof is foregone in the interest of clarity.

The authorization for use by a particular user along with other types of transactions may be sent from the automated check-out unit 102 to the central computer database at the central office 104. This may be for the purposes of updating the central office 104 database. The central computer (not shown in FIG. 1) of the central office 104, may have individual computer terminals showing the number and status of vehicles at various sites within the overall system. To this end, the central office 104 may be connected to a plurality of automated check-out units 102 in various locations in a particular urban location, or at a plurality of urban locations throughout a region. Computer programs within the central computer (not shown in FIG. 1) will monitor the flow of cars and signal operators when a particular action has to be carried out, such as moving a particular vehicle to a particular location. The operators will pass this information on to service personnel at the user's sites through either a computer network or other communication techniques, such as by cellular telephone or radio. The details of the automated check-out unit 102 as well as the central computer (not shown in FIG. 1) of the central office 104 will be described in further detail in illustrative embodiments herein below.

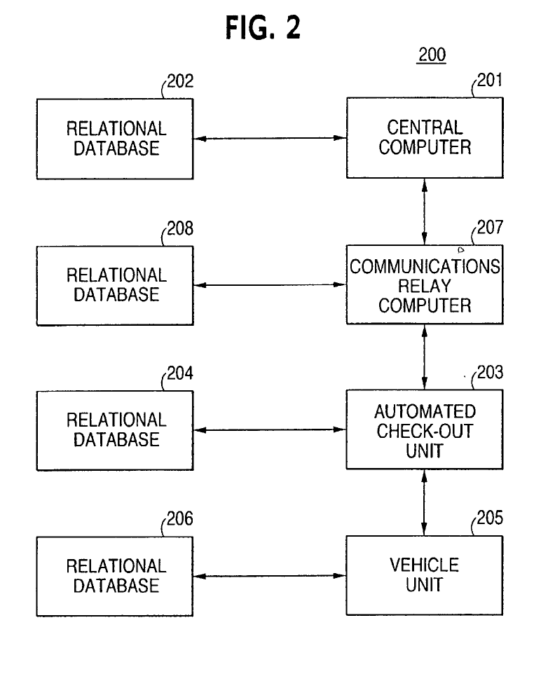

Turning to FIG. 2, a central computer system 200 according to an exemplary embodiment of the present invention is shown in functional block diagram form. The central computer system 200 has the useful function of coordinating user need with vehicle inventory. To effect this, the central computer 201 has monitoring program which constantly monitors vehicle activity. The central computer system 200 will show the location of all available vehicles, as well as project vehicle demand by car type on a periodic basis, for example an hour by hour basis. Moreover, the central computer system 200 also will show the actual ingress and egress of vehicles within its network of vehicles; and will compare the number of vehicles available with the projected demand for vehicles. These projections along with actual vehicle trip records may be recorded in relational database 202. According to an illustrative embodiment, company personnel, for example in central office 104, monitor the cars available and the projected ingress of vehicles versus the projected demand for vehicles on a real-time basis. This monitoring will prompt the personnel to take active steps to move vehicles from one location to another to assure a suitable supply of vehicles based on projected demand at each particular location. While in the illustrative embodiment personnel effect the monitoring scheme, it is clear that this may be automated via central computer 201 and suitable software.

The relational database 202 is a useful element in the central computer system 200. The relational database 202 provides a technique of organizing related data in a tabular form. The tables may be groups of records with a similar record format. This format may consist of individual data fields to store individual pieces of data such as an individual's ID number, trip type, start time, start location ID, etc. Each record in a table has a unique identifier.

In the illustrative embodiment shown in FIG. 2, a communications relay computer 207 adds a relay function between the central computer 201 and the automated check-out unit 203. The communications relay computer 207 may include a relational database 208, which also organizes useful data in tabular form. As described below, the relational database 208 may be a subset of relational database 202. Moreover, as described below, the communications relay computer 207 relays transactions to other automated check-out units (not shown) of the central computer system 200.

One useful feature of the central computer system 200 is that the relational database 202 will be a unique type of relational database. To this end, it is a distributed database. The primary relational database is relational database 202, being located at location of the central computer 201. However, there may be a subset of primary databases according to the illustrative embodiment of FIG. 2. For example, there may be a subset of the primary relational database in each of the automated check-out units 203. To wit, in the illustrative embodiment of FIG. 2, each automated check-out unit 203 has its own relational database 204, which is a subset of relational database 202. Additionally, there may even be a smaller subset of relational databases in each vehicle. To wit, each vehicle 205 has a relational database 206, which is illustratively a subset of the relational database 202.

The distributed nature of the relational databases 202, 204, 206 and 208, is particularly advantageous from the perspective of speed. In the case of the automated check-out unit 203, each automated check-out unit 203 will have stored therein all necessary information to allow a particular user to check-out a vehicle. In addition to making the check-out time very short, this strategic redundancy of the data also fosters a more robust central computer system. If, for some reason, the central computer 201 is out of communication with an automated check-out unit 203, the automated check-out unit 203 having relational database 204 may continue to function for a period of time, illustratively a number of hours. Moreover, for purposes of reliability, it may be useful to incorporate an uninterruptible power supply for each active component of the central computer system 200. Accordingly, potential problems due to power failures can be mitigated to a great extent according to the illustrative embodiment shown in FIG. 2. For example, if one automated check-out unit 203 fails due to a power outage, other automated check-out units (not shown) may continue to function. The intent of this design is to make the availability of the vehicles as dependable as possible and to reduce the impact of such factors as power, communications or computer failures on this availability. For clarity of discussion, FIG. 2 shows the illustrative architecture of the central computer system 200 linked to one automated check-out unit 203. Clearly, the central computer system 200 may include a plurality of automated check-out units 203. Each of these automated check-out units would be linkable to a plurality of vehicle units 205. Of course, each of the plurality of automated check-out units 203 and vehicle units 205 would include respective relational databases 204 and 206.

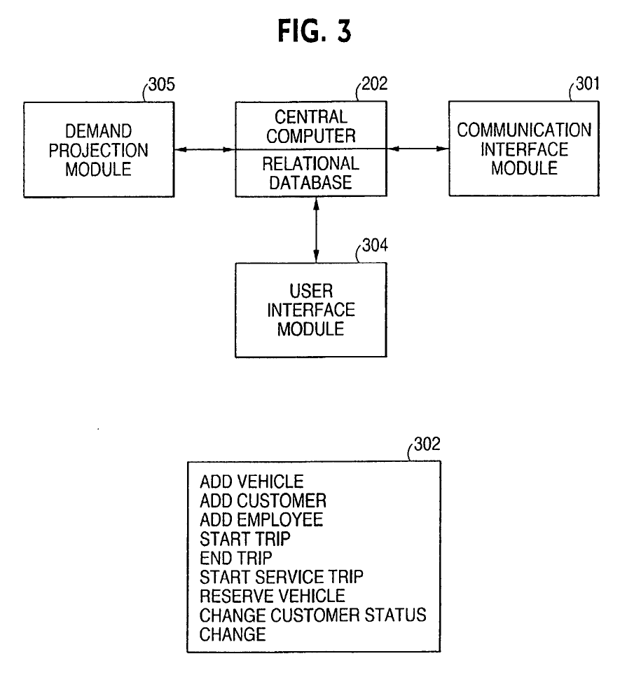

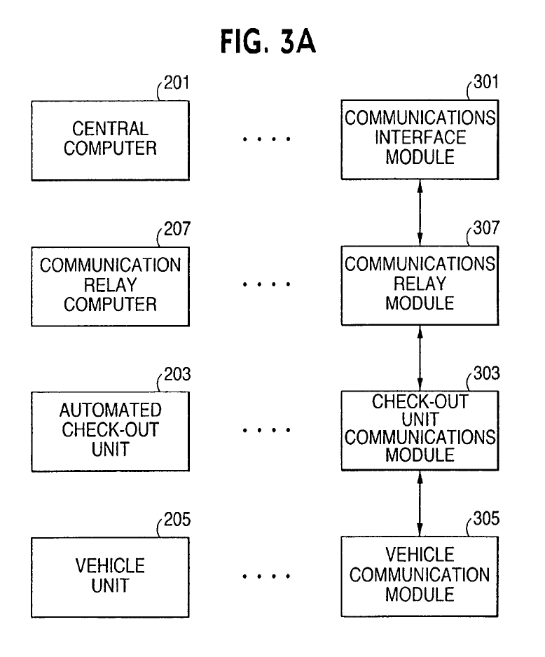

Supporting the central computer system 200 are a number of software modules, referred to herein as the central computer system software modules. Illustratively, the software for the central computer system 200 may be divided into three parts: A communications interface module; a user interface module; and a demand projection module. Turning to FIGS. 3 and 3a, functional block diagrams of illustrative central computer system software modules are shown.

The communications interface module 301 links the central computer system 200 together. The central computer 201 is linked to an automated check-out unit 203 via the communications relay computer 207. Each of these computers contains a corresponding software module. The central computer's module is communications interface module 301. It sends and receives a single transaction to the communications relay module 307 in the communications relay computer 207. The communications relay computer 207 in turn sends the message to all of the automated check-out units 203. This message is received by the check-out unit communication module 303, which in turn sends the message to the vehicle units 205 where it is received by the vehicle's communications module 305.

The communication interface module 301 effects all transactions within the central computer system 200. These transactions are distributed through the entire central computer system 200 by way of the communication interface module 301. For example, if a new customer is added by the central computer system 200, a record is added within the central computer system 200 and a transaction is sent to each of the automated check-out units 203 of the system to add a record to their respective relational databases 204. This transactional event is effected by the communications interface module 301, which sends a messages to the communications relay unit 207. This unit creates a new message record in its relational database 208 for each automated check-out units 203 with which it communicates. After each automated check-out unit 203 has processed the message and sent back an acknowledgement, the communications relay module 307 updates its database 208. Again, the communications which may be used to effect the transmission of data between the various components of the central computer system are known. Illustratively, these may be via standard asynchronous transfer mode (ATM) schemes, synchronous optical network (SONET) schemes and synchronous digital hierarchy (SOH) schemes, to name a few.

In each automated check-out unit 203, the record illustratively contains less information than is recorded in the central computer 201. By virtue of the communications interface module 301 the automated check-out unit 203 will send messages to each vehicle at its particular site (within its database) adding a customer record to each relational database 206 of each vehicle unit 205. This information (record) may then be used to validate future communications with a particular vehicle unit 205. Moreover, the vehicle communications interface module 306 illustratively assigns an identifying number to each vehicle unit 205, and will change the assigned identifying number in prescribed manner after each transaction throughout the day. Consequently, according to an illustrative embodiment of the present invention, each transaction between a vehicle unit 205 and an automated check-out unit 203 will be unique by virtue of the communications interface module 301. This provides an added measure of safety, as a would-be thief having intercepted a transaction would not be able to rely on the identifying information at a later point in the day.

The above description of the communications interface module 301 is merely illustrative, and it is of interest to note that other functions may be effected by the communications interface module 301. For example, when a customer/user checks out a vehicle, the automated check-out unit 203 sends a transaction to the central computer 201 to inform them of the event. This signal is intercepted by the communications relay module 307 and sent to all the other automated check-out units 203 in the central computer system 200. In this way if a user goes to another check-out unit (not shown), that automated check-out unit has information on the user's status and which vehicle the user is using. As such, the check-in process can take place. An overall purpose of the communications interface module 301 is to keep the various relational databases coordinated. All of the transactions are uniquely identified by the communications interface module 301. If, for example some transactions are overlooked for whatever reason, for example a power outage, when a particular computer (either in the automated check-out unit 203 or the central computer 201) is functional once again, the transactions are resent to that computer so that it could get back in coordination with all of the other units within the central computer system 200. Other illustrations of transactions, which are communicated by the communications interface module 301 are shown in FIG. 3 in block 302. Clearly the types of transactions listed in block 302 of FIG. 3 are merely illustrative, and other possible types of transactions may be effected by software of the communications interface module 301.

Another useful software module incorporated into the illustrative embodiment of FIG. 3 is a user interface module 304. The user interface module 304 effects the monitoring of the central computer systems 200 by personnel in the central office 104. The user interface module 304 also may be used to show the actual ingress and egress of vehicles within the central computer system and will compare the numbers of vehicles on-hand at each site with projected demand. These projections of demand along with actual vehicle trip records will be recorded within the central computer relational database 202. Company employees will be able to monitor the vehicles on-hand as well as the projected in-flow versus the projected demand on a real-time basis by virtue of the user interface module 304. This fosters the ability to take action with foresight and relocate vehicle from places where demand may be light to locations where demand may be heavy.

The central computer system 200 may also do administrative functions, such as add new customers and employees to the system. This may be effected through the action by employees at the central office 104 and the transactions are effected through the coordinated software of the user interface module 304 and the communications interface module 301. Additionally, and again for purposes of illustration, price changes may be effected and changes to customer status may be effected as well through the central office input via the user interface module 304 and its coordination with the communications interface module 301. The central computer system's 200 billing process and management reports to evaluate operation may be effected through the user interface module 304 and are a few of the types of activities that will not be sent to the communications interface module 301. Generally, these types of activities will be confined to the central computer 201.

Finally, the demand projection module 305 provides a very useful function to the central computer system 200 by substantially assuring that customers will have access to vehicles. Demand projections are generally historical based on previous demands figures. To wit, because all of the trips by all of the vehicles in a particular fleet are recorded on a periodic basis, for example daily, records may then be summarized into summary records which give daily trip totals by location, vehicle type, time of day and by day of the week. Of course, these are merely illustrative and other data may be used to provide an accurate summary of vehicle use. From the summary records, statistical analysis may be carried out by the software of the demand projection module 305. These summary records may be calculated by various demand categories, for example the mean number of trips leaving a particular location between a certain time on a certain day in a particular vehicle type. These statistical means may then be calculated for summary records over a 90-day period and variances and standard deviation may also be determined. Of course, other statistical analysis may be carried out from these data. Illustrative uses of the demand projection module 305 in addition to that described immediately above includes, but is not limited to, the number of vehicles required by a particular location or the probability of finding a vehicle at a particular location. This ultimately may be useful in determining the systems' level of performance and may be useful in effecting quality control measures to improve the level performance of the system. Customer personnel may also further monitor the flow of vehicles in real-time by virtue of the demand projection module 305, and may move vehicles to locations having unusually high variations in demand so that a customer should have access to a vehicle. Again, this monitoring may also be automated as described herein.

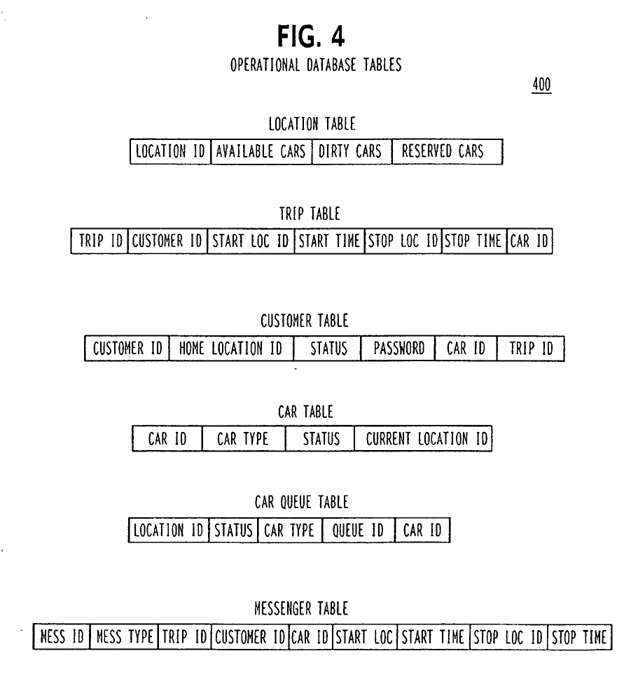

Turning to FIG. 4, illustrative operational database tables for use within the central computer system 200 are shown. The operational database tables 400 may be used to incorporate data which may be used to define locations served; customer; vehicles; vehicle types; status; and the present location of vehicles. The operational part of the database tables 400 contain a record of each trip. Each trip record has a start and stop time of every trip, with start and stop locations, customer ID number, vehicle ID number, etc. These are shown, in the various tables of the operational database tables 400 of FIG. 4. The operational tables are found in the relational databases 202, 204, 206, 208. The relational database 208 is a message processing database. It will contain the message table and a record of how each message was processed by the central computer 201 and each automated check-out unit 203. The trip tables will be deleted automatically after a period of time from the levels of architecture of the central computer system 200, which are below the central computer.

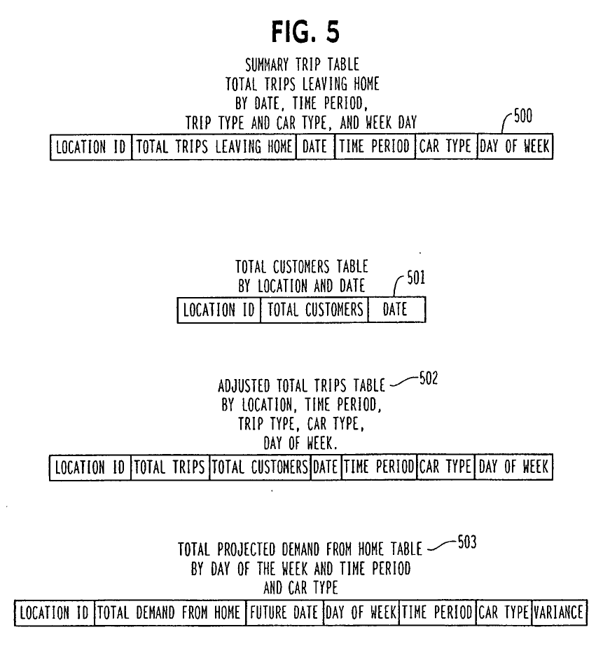

Next, according to an illustrative embodiment of the present invention shown in FIG. 5, a summary trip table 500 is shown. The summary trip table 500 supplements the operational tables. To this end, the operational tables are a record of what is occurring or has occurred in a particular location, vehicle, customer, etc. The summary trip table 500 is a summary of a particular period of time in the past, for example the number of trips leaving a particular site at a particular time on a particular day in a particular vehicle type. These records are used to prepare demand projections used in the demand projection module 305 within the central computer system 200. With the records of the summary trip table 500 may be created by adding values in other records. For example, if a certain number of customers left a particular location on a particular day in a particular time period in a particular type of vehicle, a corresponding number of separate records in the operational database trip table would be recorded. However, only one summary record would be recorded in the summary trip table 500. The summary trip table 500 would, however, have the total number of “total trips leaving home” field corresponding to the particular number of recorded in the operational database trip table. A trip record is the end product of two types of transactions that originate at the automated check-out unit 203. A customer checks out a car which generates the trip record, and a customer checks in a car which completes a trip record. These transactions cause trip records to be completed in the 206, 204 and 202 databases. In the 202 database they are used to prepare a customer's bill.

In a deployed system, the number of customers in a particular location (for example, a building) is subject to constant change. The total customers table 501 keeps a tabular record of the total number of customers by date and location identifier. The number of customers in the total customers table 501 is used to adjust the number of trips during a previous period with the number of customers currently using the system.

Next, the adjusted total trips table 502 is used to calculate statistical data from a previous group of summary records. The adjusted total trips table 502 adjusts the number of trips by customers during a previous period with the current number of customers. For example, if there are currently 200 people using the shared vehicle system of the present invention and these 200 people live in Building A; and during some previous period only 100 were using the system in that particular Building A, then the total number of trips in the past would be doubled. This will give a better estimate of the current potential demand. The mean, variance and standard deviation may be calculated from these adjusted records maintained in the adjusted total trips table 502. This processing is done be the demand projection module 305. The records in the adjusted total trips table 502 may be recalculated on a daily basis based upon the current number of customers. The length of the period of the calculation will remain the same. Records for a particular day may be added to the period and records for the last day of the previous period may be deleted from consideration. Finally, total projection demand from home table 503 is a statistical mean of the group of adjusted total trips determined by the adjusted total trips table 502.

For purposes of illustration, and in no way for the purposes of limitation, the following exemplary elements may be used in carrying out the invention. With regard to the automated check-out unit, 102 and 203, the following hardware may be implemented. In an illustrative embodiment, the automated check-out unit 102 and 203 may incorporate a Gilbarco, Inc., E-crin unit. This unit is a remote point of sale unit which is conventionally implemented at gas stations. Typically, a unit such as this is run from a personal computer inside the gas station. According to the illustrative embodiment of the present invention, the unit may be customized by installing a small PC/104 unit inside the E-crin unit. This small embedded computer (PC/104) has a modulator/demodulator (modem) that is linked to the central computer and wireless modem commercially available, such as that produced by Freewave Technologies. This modem is in radio contact with another wireless modem in the vehicle control units in each of the vehicles. According to the public access vehicle system of the present invention, the central computer system 200 is the overall master. The central computer system 200 communicates directly with the automated check-out unit 203, and as such, the automated check-out unit 203 is the slave of the central computer system 200. When polled by the central computer system 200, the automated check-out unit 203 sends back messages that it is generated for the central computer system 200 and receives and processes any messages generated by the central computer system 200.

The automated check-out unit (102, 203) is the master of the link between itself and the vehicle units 205 at its particular location. This unit relays any messages from the central computer system 200 to the vehicle units 205, and also any messages it generates itself, such as general status checks or vehicle check-out instructions. As described previously, the relational databases 204 of the automated check-out units 203 arc a subset of the relational database 202 in the central computer 201.

For more positive identification and to prevent fraud associated with credit cards and pin numbers, a finger print identification unit will be attached to the automated check-out unit 203. For purposes of illustration, and in no way for the purposes of limitation, this unit could be the MV 1100 produced by Biometric Identification Inc. This unit would fit inside the Gilbarco E-crin and be attached to a serial port of the embedded computer (PC/104).

To illustrate a check-out transaction, if a particular customer desires to check-out a vehicle, the following transaction sequence could occur:

1. User enters identification card.

2. The automated check-out unit (ACU) checks in the customer table to see if the identification card is valid.

3. If its valid the ACU tells user to enter customer password and for customer to place thumb on the thumb reader.

4. The ACU checks in the customer table to see if the password and fingerprint are valid and user's status is eligible.

5. If this is in order the ACU prompts user for a car type.

6. Once the user makes his/her selection, the ACU checks in the car queue table for the next available car.

7. The ACU sends a signal to the car to unlock its doors and allow the ignition to operate.

8. Once the vehicle control unit radios back that it has completed these transactions, the ACU informs the customer which car to use.

9. The ACU then creates a new trip record and updates the customer's record.

10. A message is created and put in the message table.

11. When the ACU is polled by the CCS the message is sent to the CCS.

12. The CCS processes the message. It creates a new trip record and updates the customer's record in its database.

13. The CCS then sends the message to the other ACU's and they in turn update their copy of the customer's record.

Finally, the invention of the present disclosure may incorporate an automated key dispenser, which may be particularly useful in the temporary addition of vehicles to a local fleet. In this event, when additional vehicles are added on an emergency basis and a control unit is not located in each vehicle, a key dispenser may have to be used. This automated key dispenser may be in the form of a bank of mailbox-type slots. A manual lock on a door will be replaced by an electronic lock. One variation to the procedure is that instead of signaling a car, the automated check-out unit 203 and 102 will unlock one of the compartments and advise a customer to remove keys from the appropriate compartment. Once the customer has done this, the automated check-out unit will relock the compartment. Finally, the vehicle control unit is disposed within each of the vehicles 205.

The control unit (not shown) within the vehicle unit 205 controls the use of a vehicle by way of commands from the automated check-out unit 102 and 203. This control unit may reside in a special container built for the vehicles. The vehicle control unit may include a PC/104 computer and a wireless modem. The PC/104 computer may have a relay board that switches off the power to the various vehicle's structures, such as door locks, ignition, etc. The software which controls the automated check-out unit runs in a continuous loop waiting for instructions from the automated check-out unit 203,102. When a command is received from the automated check-out units 102, 203 the commands are carried out and the continuous loop is reinitiated. The vehicle control unit may also may also be used to monitor various car status information, such as fuel levels, and report this back to the automated check-out unit where it can relayed back to the central computer system 200. In the above described embodiments, certain features have been described to illustrate the invention.

These features are not intended to be exhaustive or limiting of the present invention. For example, the invention of the above described embodiments includes the active involvement of employees/personnel at a central office to carry out various functions as described herein. To some extent, if and possibly completely, the function of these employees/personnel may be completely automated through appropriate hardware and software implementations. Moreover, the communication between various units may be through a hardwired scenario, or by optical fiber communication. Moreover, and particularly in mobile or remote location structures, the communication vehicle may be via a wireless device, such as a wireless modulator/demodulator (modem). Again, this is intended in no way to be exhaustive, as other techniques for effecting the communication such as wired systems, optical fiber communication systems, as well as cellular telephony, local multipoint distribution systems (LMDS) and satellite communication systems, to name illustrations, may be used in various applications as would be readily understood by one having ordinary skill the art. As such, while illustrations above may not have specifically mentioned these during descriptions of a particular embodiment, it is clear that these other types of communications may be incorporated into the above embodiments as would be practical.

The invention having been described in detail in connection through a discussion of exemplary embodiments, it is clear that modifications of the invention will be apparent to one having ordinary skill in the art having had the benefit of the present disclosure. Such modifications and variations arc included in the scope of the appended claims.

We claim:

1. A public access vehicle system, comprising:
an automated check-out unit operatively coupled to at least one vehicle, said automated check-out unit responsive to a customer request, wherein said automated check-out unit may enable said at least one vehicle for use by a customer.

2. A public access vehicle system as recited in claim 1, wherein said automated check-out unit is operatively coupled to a central computer.

3. A public access vehicle system as recited in claim 2, wherein said central computer includes a relational database.

4. A public access vehicle system as recited in claim 1, wherein each of said at least one vehicles include a vehicle control unit.

5. A public access vehicle system as recited in claim 4, wherein each of said vehicle control units include a relational datebase.

6. A public access vehicle system as recited in claim 1, wherein said central computer is adaptively coupled to a demand projection module.

7. A public access vehicle system as recited in claim 1, wherein said central computer is adaptively coupled to a user interface module.

8. A public access vehicle system as recited in claim 1, wherein said central computer is adaptively coupled to a communications interface module.

9. A public access vehicle system as recited in claim 1, further comprising an operational database table.

10. A public access vehicle system as recited in claim 1, further comprising a summary trip table.

11. A public access vehicle system as recited in claim 1, further comprising a total customer's table.

12. A public access vehicle system as recited in claim 1, further comprising an adjusted total trips table.

13. A public access vehicle system further comprising a total projected demand from home table.

14. A method of providing public access vehicles, comprising:
a.) receiving an input at an automated check-out unit;
b.) performing at least one operation based on said input; and
c.) issuing a command based on said at least one operation.

15. A method as recited in claim 13, wherein said command enables a vehicle.

16. A method as recited in claim 14, wherein said at least one operation includes verifying a customer identification.

17. A method as recited in claim 13, wherein said operation includes checking availability of a requested vehicle.

18. A method as recited in claim 13, wherein said operation includes checking for customer financial account prior to step (c).

19. An automated service system comprising:
a plurality of automated check-out units, each having a respective local database and a respective fleet of vehicles at corresponding locations, each of the plurality of automated check-out units confirming identification and status of a customer based on input customer information, assigning a vehicle from the respective fleet based on the input customer information, transmitting an enable command to the assigned vehicle and identifying the assigned vehicle for the customer; and
a central computer, operatively coupled to each of the plurality of automated check-out units and including a relational database of all vehicles in the fleets, the central computer monitoring activity of all the vehicles, predicting demand for vehicles at all of the locations and automatically assigning vehicles to maintain an adequate number of vehicles in each of the fleets.

20. A public access vehicle system as recited in claim 19, wherein each of the vehicles includes a control unit that receives an enable command from a corresponding one of the plurality of automated check-out units and enables ignition and lock systems of a corresponding vehicle responsive thereto.

21. A public access vehicle system as recited in claim 19, wherein each location includes an automated key dispenser that automatically dispenses a key for the assigned vehicle to the customer, under control of a corresponding one of the plurality of automated check-out units.

22. A public access vehicle system as recited in claim 19, wherein said central computer is operatively coupled to a communications relay computer.

23. A public access vehicle system as recited in claim 22, wherein said communications relay computer operatively is coupled to each of said plurality of automated check-out units.

24. A public access vehicle system as recited in claim 2, wherein said central computer is operatively coupled to a communications relay computer.
